(19) United States
(12) Patent Application Publication
(10) Pub. No.: US 2021/0289752 A1
(43) Pub. Date: Sep. 23, 2021

(54) Interchangeable Pet Accessory

(71) Applicant: Cindy Townley, Chula Vista, CA (US)

(72) Inventor: Cindy Townley, Chula Vista, CA (US)

(21) Appl. No.: 17/207,556

(22) Filed: Mar. 19, 2021

Related U.S. Application Data
(60) Provisional application No. 62/991,924, filed on Mar. 19, 2020.

(51) Int. Cl. A01K 27/00

(52) U.S. Cl. CPC A01K 27/006; A01K 27/002

(57) ABSTRACT

An interchangeable pet accessory is an apparatus that easily and securely worn by a pet. The apparatus includes a main strap and at least one band. The main strap is a visible accent for the pet along the back of the pet. The at least one band secures the main strap around the neck of the pet. The at least one band preferably includes a neck-bracing band. The main strap may be fixed with the at least one band or removably attached with a main fastener. The apparatus may further include at least one first decorative ornament and at least one second decorative ornament that visually distinguishes the main strap and the at least one band, respectively. Various embodiments of the apparatus may further include a hip-bracing band, a tail-bracing band, a belly-bracing band, and a headpiece. Each band further accentuates and accessorizes the pet.

The current application claims a priority to the U.S. provisional patent application Ser. No. 62/991,924 filed on Mar. 19, 2020.

### FIELD OF THE INVENTION

The present invention generally relates to pets. More specifically, the present invention is an interchangeable pet accessory.

### BACKGROUND OF THE INVENTION

Many pet owners prefer to put a collar, harness, or other cloth articles on their pets for various purposes. However, those clothing articles usually do not have enough versatility to allow the user to decide which part of the article of clothing to be placed on which body part of the pet. Moreover, the existing clothing articles do not allow the user to display certain words or other decorations to avoid confusion or other issues.

Therefore, an objective of the present invention is to provide a new pet accessory that provides solutions to all issues mentioned above. An owner may put some or all of components of the present invention on certain body parts of a pet. The owner may also layer the present invention on top of clothing articles already being worn by the pet. The owner may place various decorations or words onto the present invention to deliver different messages to other people. For example, the owner may put gender-identifying messages on the present invention so other people do not need to guess the gender of the pet.

### BRIEF DESCRIPTION OF THE DRAWINGS

FIG. 1 is a side view of a preferred embodiment of the present invention with a main strap and a neck-bracing band.

FIG. 2 is a top side view of an alternate embodiment of the present invention with the main strap, the neck-bracing band, and a hip-bracing band.

FIG. 3 is a side view of an embodiment of the present invention with the main strap, the neck-bracing band, the hip-bracing band, and a headpiece.

FIG. 4 is a side view of an embodiment of the present invention with the main strap, the neck-bracing band, a belly-bracing band, the hip-bracing band, and the headpiece.

FIG. 5 is a top side view of an alternate embodiment of the present invention with the main strap, the neck-bracing band, the hip-bracing band, and a tail-bracing band.

FIG. 6 is a top exploded view of an alternate embodiment of the present invention with the main strap, the neck-bracing band, and a hip-bracing band.

FIG. 7 is a bottom view of an alternate embodiment of the present invention with the main strap, the neck-bracing band, and a hip-bracing band.

### DETAIL DESCRIPTIONS OF THE INVENTION

All illustrations of the drawings are for the purpose of describing selected versions of the present invention and are not intended to limit the scope of the present invention.

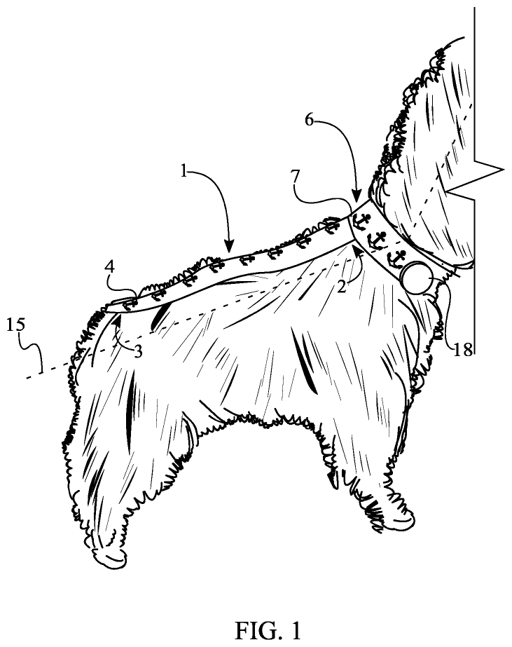

The present invention is an interchangeable pet accessory. The present invention allows for customization to reflect various stylistic preferences of an owner. The pet is preferably a dog. However, it is understood that similar pets such as cats may also wear the present invention. The present invention may be directly worn by a pet or may be worn on top of garments to further accent the garment. Moreover, the present invention may be along with collars and harnesses, and the present invention may be used without them. Furthermore, the present invention visually identifies the gender of the pet depending on the style of the present invention and any decorative elements to further differentiate the gender of the pet. In order to enhance the style for a pet, the present invention may comprise a main strap 1 and at least one band 6, seen in FIG. 1. The main strap 1 serves as the most visible portion of the present invention and extends along the back of the pet. The main strap 1 remains positioned along the back of the pet as the main strap 1 may comprise a first strap end 2, a second strap end 3, a visible elongated surface 4, and a hidden elongated surface 5. The first strap end 2 connects the main strap 1 with the at least one band 6. The first strap end 2 and the second strap end 3 define the overall length of the main strap 1. The visible elongated surface 4 upholds and presents decorative accents. The hidden elongated surface 5 presses against the body of the pet. The at least one band 6 secures the present invention around the pet. In the preferred embodiment of the present invention, the at least one band 6 may comprise a neck-bracing band 7. The neck-bracing band 7 wraps around the neck of the pet. The neck-bracing band 7 may serve as a collar for the pet or may be positioned around the collar of a pet.

The overall configuration of the aforementioned components allows the present invention to be easily worn by a pet. The main strap 1 traverses along the length of the pet as the first strap end 2 is positioned opposite the second strap end 3 along the main strap 1, seen in FIG. 1. The visible elongated surface 4 is positioned opposite the hidden elongated surface 5 about the main strap 1. The neck-bracing band 7 is positioned adjacent with the first strap end 2, and the main strap 1 is laterally mounted with the neck-bracing band 7. This arrangement comfortably secures the present invention to the pet. More specifically, an animal midline 15 is centrally positioned through the neck-bracing band 7. The animal midline 15 is the central body plane of the pet that traverses from the neck to the tailbone. The visible elongated surface 4 is oriented away from the animal midline 15, thereby presenting any visual distinctive accents to individuals around the pet. Consequently, the hidden elongated surface 5 is oriented towards the animal midline 15.

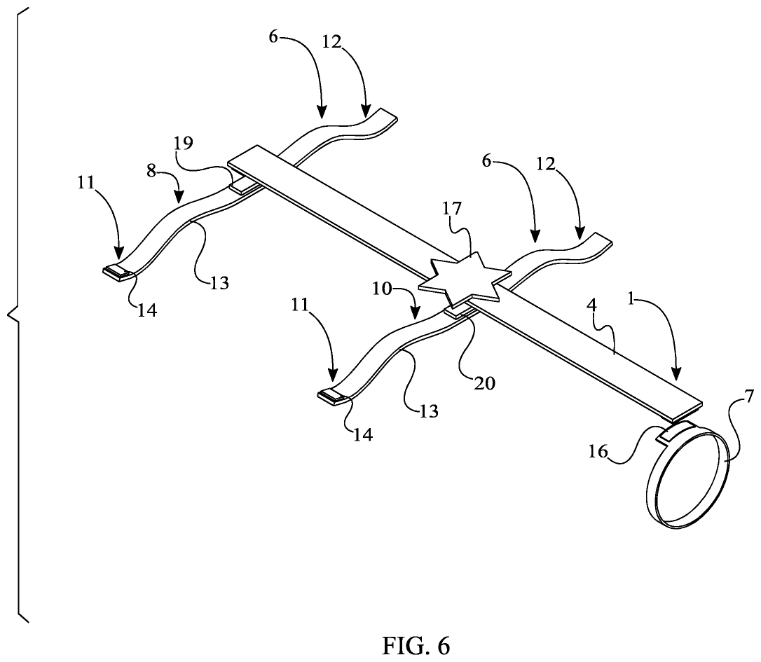

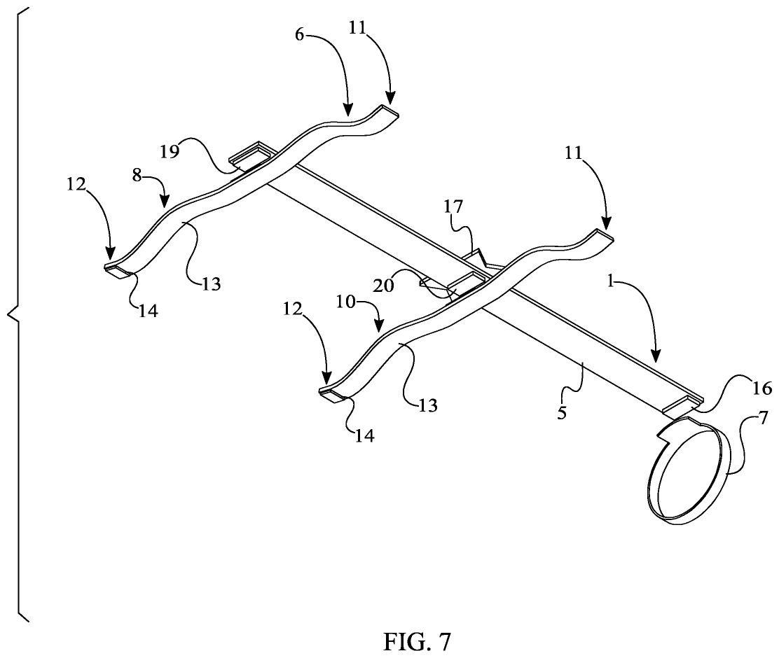

The present invention provides versatility for a pet as the present invention may further comprise a first main fastener 16 for some embodiments. The first main fastener 16 allows the main strap 1 to be interchanged with the neck-bracing band 7, seen in FIG. 6 and FIG. 7. The first main fastener 16 may be a button and a buttonhole, a hook and loop, Velcro patches, and so on. The main strap 1 is removably attached with the neck-bracing band 7 by the first main fastener 16, effectively securing a desired main strap 1 with the neck-bracing band 7. For some embodiments, conversely, the main strap 1 is fixed with the neck-bracing band 7.

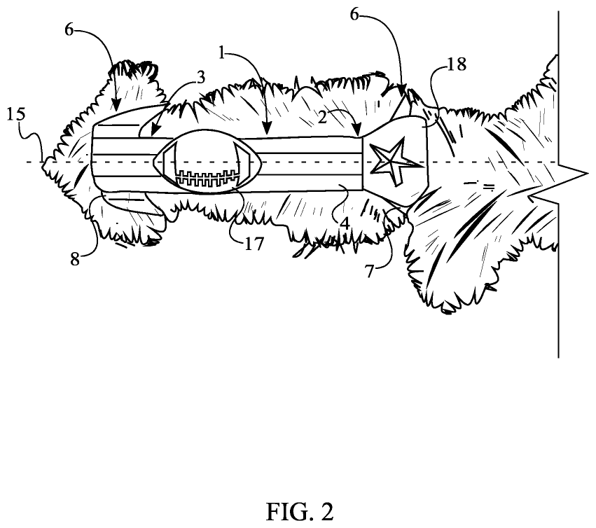

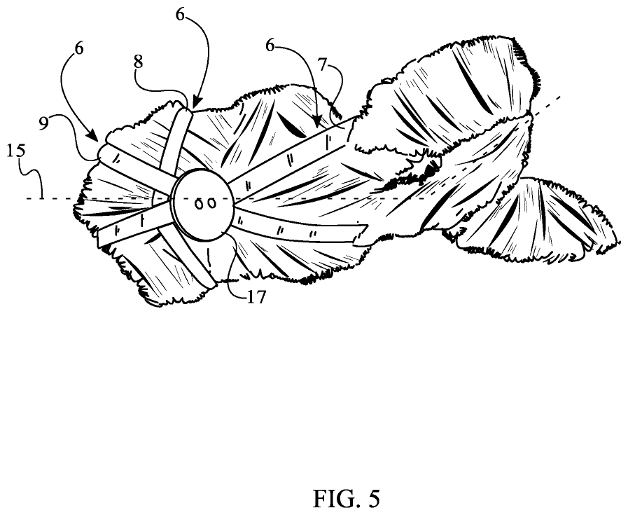

The main strap 1 may be further distinguished as the present invention may further comprise at least one first decorative ornament 17, seen in FIG. 2, FIG. 5, FIG. 6, and FIG. 7. The at least one first decorative ornament 17 may include, but is not limited to gemstones, badges, flowers, buttons, and studs. The at least one first decorative ornament 17 is laterally positioned within the main strap 1 and is fixed onto the visible elongated surface 4, thereby visually distinguishing the pet with the at least one first decorative ornament 17.

Similarly, the at least one band 6 may be further distinguished as the present invention may further comprise at least one second decorative ornament 18, seen in FIG. 1 and FIG. 2. As for the at least one second decorative ornament 18, the at least one second decorative ornament 18 may include, but is not limited to gemstones, badges, flowers, buttons, and studs. The at least one second decorative ornament 18 is laterally positioned about the at least one band 6 and is fixed with the at least one band 6, thereby visually distinguishing the pet with the at least one second decorative ornament 18.

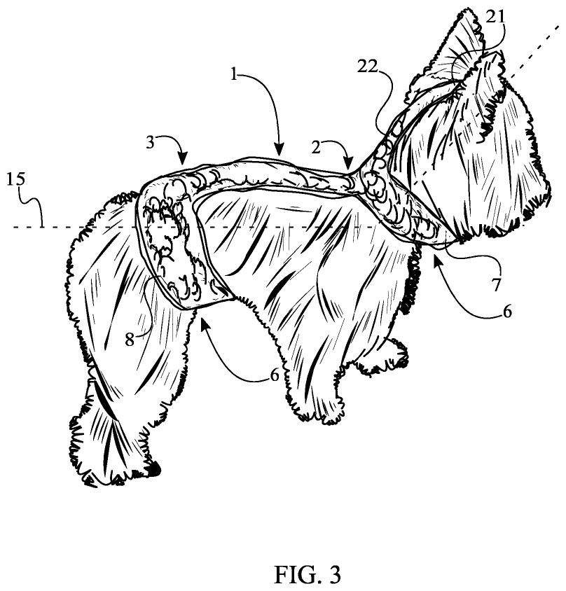

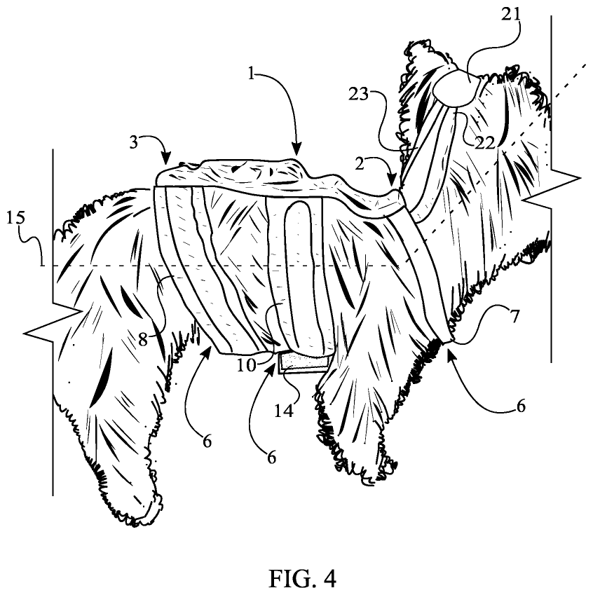

In alternate embodiments of the present invention, the at least one band 6 may further comprise a hip-bracing band 8, seen in FIG. 2, FIG. 3, FIG. 4, FIG. 5, FIG. 6, and FIG. 7. The hip-bracing band 8 wraps around the hips of the pet, more securely mounting the present invention around the pet. The hip-bracing band 8 is positioned adjacent with the second strap end 3, thereby aligning the hip-bracing band 8 around the hips of the user. In order to connect the hip-bracing band 8 with the main strap 1, the hip-bracing band 8 is laterally mounted with the main strap 1. The body of the pet continually traverses through the neck-bracing band 7 and the hip-bracing band 8 as the animal midline 15 is centrally positioned through the hip-bracing band 8.

The hip-bracing band 8 may also be interchangeable for some embodiments of the present invention, as some embodiments of the present invention may further comprise a second main fastener 19, seen in FIG. 6 and FIG. 7. The second main fastener 19 may be a button and a buttonhole, a hook and loop, Velcro patches, and so on. The main strap 1 is removably attached with the hip-bracing band 8 by the second main fastener 19, effectively securing a desired hip-bracing band 8 with the main strap 1. For some embodiments, conversely, the main strap 1 is fixed with the hip-bracing band 8 in further embodiments of the present invention.

In some embodiments of the present invention, the at least one band 6 may further comprise a tail-bracing band 9, seen in FIG. 5. The tail-bracing band 9 wraps around the tail of the pet, more securely mounting the present invention around the pet. The tail-bracing band 9 is positioned adjacent with the second strap end 3, thereby aligning the tail-bracing band 9 around the tail of the pet. In order to connect the tail-bracing band 9 with the main strap 1, the tail-bracing band 9 is laterally mounted with the main strap 1. The tail-bracing band 9 remains around the tail of the pet regardless of any wagging, as the tail-bracing band 9 is preferably positioned perpendicular to the hip-bracing band 8.

In some embodiments of the present invention, the at least one band 6 may further comprise a belly-bracing band 10, seen in FIG. 4, FIG. 6, and FIG. 7. The belly-bracing band 10 wraps around the belly of the pet. The belly-bracing band 10 is positioned in between the first strap end 2 and the second strap end 3, thereby aligning the belly-bracing band 10 around the belly of the pet. In order to connect the belly-bracing band 10 with the main strap 1, the belly-bracing band 10 is laterally mounted with the main strap 1. The body of the pet continually traverses through the neck-bracing band 7 and the belly-bracing band 10 as the animal midline 15 is centrally positioned through the belly-bracing band 10.

The belly-bracing band 10 may also be interchangeable for some embodiments of the present invention, as some embodiments of the present invention may further comprise a third main fastener 20, seen in FIG. 6 and FIG. 7. The third main fastener 20 may be a button and a buttonhole, a hook and loop, Velcro patches, and so on. The main strap 1 is removably attached with the belly-bracing band 10 by the third main fastener 20, effectively securing a desired belly-bracing band 10 with the main strap 1. For some embodiments, conversely, the main strap 1 is fixed with the belly-bracing band 10 in further embodiments of the present invention.

In order to tighten or loosen the at least one band 6 around the pet, for some embodiments of the present invention, the at least one band 6 may each further comprise a first band end 11, a second band end 12, a band body 13, and a supplementary fastener 14, also seen in FIG. 6 and FIG. 7. The first band end 11 and the second band end 12 engage with one another to define an overall circumference for the at least one band 6 to better fit the girth of the pet. The first band end 11 is positioned opposite to the second band end 12 along the band body 13. The band body 13 wraps around the body of the pet and upholds the at least one second decorative ornament 18. The supplementary fastener 14 connects the first band end 11 and the second band end 12 and secures the desired overall circumference for the at least one band 6. The band body 13 is length adjustable as the first band end 11 is removably attached to the second band end 12 by the supplementary fastener 14. Moreover, the supplementary fastener 14 is positioned opposite to the main strap 1 about the band body 13 so that the connection between the main strap 1 and the at least one band 6 is uninhibited. Furthermore, this arrangement conceals the supplementary fastener 14 underneath the body of the pet.

In order to accentuate the head of a pet, some embodiments of the present invention may further comprise a headpiece 21 and a first supplementary strap 22, seen in FIG. 3 and FIG. 4. The headpiece 21 is a decorative element that highlights the head of the pet. It is understood that the headpiece 21 attaches with the fur or coat of the pet. The first supplementary strap 22 connects the headpiece 21 with the main strap 1. The present invention continuously extends across the body of the pet as the neck-bracing band 7 is terminally fixed with the first supplementary strap 22, and the headpiece 21 is terminally fixed with the first supplementary strap 22, opposite the neck-bracing band 7. The body of the pet continually traverses through the present invention as the animal midline 15 is centrally positioned thought the headpiece 21. The headpiece 21 is more securely centered onto the head of a pet as these embodiments of the present invention may further comprise a second supplementary strap 23, seen in FIG. 4. Similar with the first supplementary strap 22, the neck-bracing band 7 is terminally fixed with the second supplementary strap 23, and the headpiece 21 is terminally fixed with the second supplementary strap 23, opposite the neck-bracing band 7. The second supplementary strap 23 is positioned offset from the first supplementary strap 22 along the neck-bracing band 7. This arrangement secures the headpiece 21 on the head of the pet regardless of any turning of and moving of the head of the pet. The second supplementary strap 23 is positioned coincident with the first supplementary strap 22 at the headpiece 21. The first supplementary strap 22 and the second supplementary strap 23 therefore taper towards the headpiece 21 from the neck-bracing band 7.

It is understood that alternate embodiments of the present invention may be combined with each other according to the discretion of the owner. For example, both the belly-bracing band 10 and the hip-bracing band 8 may be fastened with the main strap 1 along with the neck-bracing band 7. Another example may include both the tail-bracing band 9 and the belly-bracing band 10 that are fastened with the main strap 1 along with the neck-bracing band 7. Further combinations may be defined with each band of the at least one band 6, the at least one first decorative ornament 17, the at least one second decorative ornament 18, and the headpiece 21.

Although the invention has been explained in relation to its preferred embodiment, it is to be understood that many other possible modifications and variations can be made without departing from the spirit and scope of the invention as hereinafter claimed.

What is claimed is:

1. An interchangeable pet accessory comprises:
a main strap;
at least one band;
the main strap comprises a first strap end, a second strap end, a visible elongated surface, and a hidden elongated surface;
the at least one band comprises a neck-bracing band;
the first strap end being positioned opposite the second strap end along the main strap;
the visible elongated surface being positioned opposite the hidden elongated surface about the main strap;
the neck-bracing band being positioned adjacent with the first strap end;
the main strap being laterally mounted with the neck-bracing band;
an animal midline being centrally positioned through the neck-bracing band;
the visible elongated surface being oriented away from the animal midline; and,
the hidden elongated surface being oriented towards the animal midline.

2. The interchangeable pet accessory as claimed in claim 1 comprises:
a first main fastener; and,
the main strap being removably attached with the neck-bracing band by the first main fastener.

3. The interchangeable pet accessory as claimed in claim 1 comprises:
the main strap being fixed with the neck-bracing band.

4. The interchangeable pet accessory as claimed in claim 1 comprises:
at least one first decorative ornament;
the at least one first decorative ornament being laterally positioned with the main strap; and,
the at least one first decorative ornament being fixed onto the visible elongated surface.

5. The interchangeable pet accessory as claimed in claim 1 comprises:
at least one second decorative ornament;
the at least one second decorative ornament being laterally positioned about the at least one band; and,
the at least one second decorative ornament being fixed with the at least one band.

6. The interchangeable pet accessory as claimed in claim 1 comprises:
at least one band further comprises a hip-bracing band;
the hip-bracing band being positioned adjacent with the second strap end;
the hip-bracing band being laterally mounted with the main strap; and, the animal midline being centrally positioned through the hip-bracing band.

7. The interchangeable pet accessory as claimed in claim 6 comprises:
a second main fastener; and, the main strap being removably attached with the hip-bracing band by the second main fastener.

8. The interchangeable pet accessory as claimed in claim 6 comprises:
the main strap being fixed with the hip-bracing band.

9. The interchangeable pet accessory as claimed in claim 6 comprises:
at least one band further comprises a tail-bracing band;
the tail-bracing band being positioned adjacent with the second strap end;
the tail-bracing band being laterally mounted with the main strap; and, the tail-bracing band being positioned perpendicular to the hip-bracing band.

10. The interchangeable pet accessory as claimed in claim 1 comprises:
at least one band further comprises a belly-bracing band;
the belly-bracing band being positioned in between the first strap end and the second strap end;
the belly-bracing band being laterally mounted with the main strap; and,
the animal midline being centrally positioned through the belly-bracing band.

11. The interchangeable pet accessory as claimed in claim 10 comprises:
a third main fastener; and,
the main strap being removably attached with the belly-bracing band by the third main fastener.

12. The interchangeable pet accessory as claimed in claim 10 comprises:
the main strap being fixed with the belly-bracing band.

13. The interchangeable pet accessory as claimed in claim 1 comprises:
the at least one band each further comprises a first band end, a second band end, a band body, and a supplementary fastener;
the first band end being positioned opposite to the second band end along the band body;
the first band end being removably attached to the second band end by the supplementary fastener; and,
the supplementary fastener being positioned opposite to the main strap about the band body.

14. The interchangeable pet accessory as claimed in claim 1 comprises:
a headpiece;
a first supplementary strap;
the neck-bracing band being terminally fixed with the first supplementary strap;
the headpiece being terminally fixed with the first supplementary strap, opposite the neck-bracing band; and,
the animal midline being centrally positioned through the headpiece.

15. The interchangeable pet accessory as claimed in claim 14 comprises:
a second supplementary strap;
the neck-bracing band being terminally fixed with the second supplementary strap;
the headpiece being terminally fixed with the second supplementary strap, opposite the neck-bracing band;
the second supplementary strap being positioned offset from the first supplementary strap along the neck-bracing band; and,
the second supplementary strap being positioned coincident with the first supplementary strap at the headpiece.
